(19) United States
(12) Patent Application Publication
(10) Pub. No.: US 2021/0154903 A1
(43) Pub. Date: May 27, 2021

(54) HOLLOW EXTRUSION-MOLDED MATERIAL, CROSSLINKED POLYMER THEREOF, HEAT-SHRINKABLE TUBE, AND MULTILAYER HEAT-SHRINKABLE TUBE

(71) Applicants: SUMITOMO ELECTRIC INDUSTRIES, LTD., Osaka-shi, Osaka (JP); SUMITOMO ELECTRIC FINE POLYMER, INC., Sennan-gun, Osaka (JP)

(72) Inventors: Satoshi YAMASAKI, Osaka-shi, Osaka (JP); Hayato AOI, Sennan-gun, Osaka (JP)

(73) Assignees: SUMITOMO ELECTRIC INDUSTRIES, LTD., Osaka-shi, Osaka (JP); SUMITOMO ELECTRIC FINE POLYMER, INC., Sennan-gun, Osaka (JP)

(21) Appl. No.: 16/652,327

(22) PCT Filed: May 8, 2019
(86) PCT No.: PCT/JP2019/018359

§ 371 Date: Mar. 30, 2020

(51) Int. Cl. B29C 48/00; C08L 23/06; C08K 3/016; C08K 3/22; B32B 1/08; B32B 7/028; B32B 7/12; B32B 27/08; B32B 27/20; B32B 27/30; B32B 27/34

(52) U.S. Cl. CPC B29C 48/0015; C08L 23/06; B29C 48/022; C08K 3/016; C08K 3/2279; B32B 1/08; B32B 2307/3065; B32B 7/12; B32B 27/08; B32B 27/20; B32B 27/306; B32B 27/34; C08K 2003/2217; B32B 7/028

(57) ABSTRACT

There is provided a hollow extrusion-molded material formed by drawdown molding of a resin composition, the resin composition including, as a base resin, an ethylene-ethyl acrylate copolymer, or an ethylene-ethyl acrylate copolymer and linear low-density polyethylene, the resin composition including a bromine-based flame retardant, antimony trioxide and magnesium hydroxide, wherein a composition ratio between the ethylene-ethyl acrylate copolymer and the linear low-density polyethylene, a content of the bromine-based flame retardant, a content of the antimony trioxide, and a content of the magnesium hydroxide are within specified ranges. There are also provided a crosslinked polymer of the hollow extrusion-molded material, and a heat-shrinkable tube and a multilayer heat-shrinkable tube obtained from the crosslinked polymer.

### TECHNICAL FIELD

The present disclosure relates to a hollow extrusion-molded material, a crosslinked polymer thereof, and a heat-shrinkable tube and a multilayer heat-shrinkable tube obtained from the crosslinked polymer.

### BACKGROUND ART

A hollow extrusion-molded material refers to a tube-like molded material obtained by extruding a thermoplastic resin, and particularly to a tube-like molded material having a hollow interior. The tube-like molded material obtained by extruding a thermoplastic resin, and a crosslinked polymer obtained by crosslinking the thermoplastic resin are used as a cover layer for an optical fiber in an optical fiber cord, an insulated cover layer for an insulated electric wire, and the like.

For example, as an outer layer for covering an optical fiber bare wire in a flame-retardant plastic optical fiber cord, PTL 1 discloses a tube-like molded material obtained by extruding a resin composition, the resin composition including: a polymer component composed of an ethylene vinyl acetate copolymer (EVA) and a high-pressure radical-polymerized long-chain-branched-type low-density ethylene-based polymer; a bromine-based flame retardant; antimony trioxide; and magnesium hydroxide (claim 1, paragraph 0015).

PTL 2 discloses a flame-retardant insulated electric wire covered with a crosslinked polymer of a resin composition including a bromine-based flame retardant, antimony trioxide, and magnesium hydroxide treated with a silane coupling agent, with respect to a resin component mainly composed of EVA. The covering is a tube-like molded material formed by extruding the resin composition around a conductor and covering the conductor with the resin composition (paragraph 0023).

PTL 3 discloses a heat-resistant crosslinked electric wire including a crosslinked polymer of a resin composition as an insulated cover layer, the resin composition including, as a main component, a resin composed of high-density polyethylene, low-density polyethylene, an ethylene-based copolymer, and an ethylene copolymer modified by an unsaturated carboxylic acid anhydride, the resin composition further including a bromine-based flame retardant and magnesium hydroxide. The insulated cover layer is a crosslinked polymer of a tube-like molded material formed by covering a conductor with the resin composition by an extruder to crosslink the resin.

A crosslinked polymer of a hollow extrusion-molded material obtained by extruding the resin composition described in each of PTLs 1 to 3 is enlarged in diameter and provided with heat shrinkability, to thereby obtain a heat-shrinkable tube. The heat-shrinkable tube is placed over an outer circumference of an electric wire or a portion such as a bundling portion of an electric wire or an end of a wiring, and is heat-shrunk, and the outer circumference of the electric wire or the above-described portion can thereby be covered. Thus, the heat-shrinkable tube is used for formation of insulated covering of an insulated electric wire, and protection, insulation, waterproofing, corrosion protection and the like of the above-described portion.

There is also known a multilayer heat-shrinkable tube including, on an inner circumferential surface of the heat-shrinkable tube, a resin layer (adhesive layer) that flows during heat shrinkage and adheres to the above-described portion, in order to improve the adhesiveness between the heat-shrinkable tube and the above-described portion during heat shrinkage.

### CITATION LIST

### Patent Literature

PTL 1: Japanese Patent Laying-Open No. 7-56063

PTL 2: Japanese Patent Laying-Open No. 2009-51918

PTL 3: Japanese Patent Laying-Open No. 2014-132530

### SUMMARY OF INVENTION

A first aspect of the present disclosure provides a hollow extrusion-molded material of a resin composition, the resin composition including, as a base resin, an ethylene-ethyl acrylate copolymer, or an ethylene-ethyl acrylate copolymer and linear low-density polyethylene, the resin composition including a bromine-based flame retardant, antimony trioxide and magnesium hydroxide, wherein

a composition ratio (mass ratio) between the ethylene-ethyl acrylate copolymer and the linear low-density polyethylene is 100:0 to 85:15,

with respect to 100 parts by mass of the base resin, a content of the bromine-based flame retardant is not less than 55 parts by mass and less than 90 parts by mass, a content of the antimony trioxide is less than 15 parts by mass, and a content of the magnesium hydroxide is less than 50 parts by mass, and the magnesium hydroxide has an average particle size of not less than 0.5 μm and not more than 3.0 μm.

A second aspect of the present disclosure provides a crosslinked polymer of the hollow extrusion-molded material, wherein the base resin of the hollow extrusion-molded material in the first aspect is crosslinked.

A third aspect of the present disclosure provides a heat-shrinkable tube, being a diameter-enlarged type of the crosslinked polymer of the hollow extrusion-molded material in the second aspect.

A fourth aspect of the present disclosure provides a multilayer heat-shrinkable tube including the heat-shrinkable tube in the third aspect, and an adhesive layer disposed on an inner circumferential surface of the heat-shrinkable tube and made of a hot melt resin.

### BRIEF DESCRIPTION OF DRAWINGS

FIG. 1 is a perspective view of a heat-shrinkable tube according to a third aspect of the present disclosure.

FIG. 2 is a perspective view of a multilayer heat-shrinkable tube according to a fourth aspect of the present disclosure.

FIG. 3 is a cross-sectional view taken along line A-A′ in FIG. 2.

### DETAILED DESCRIPTION

### Problem to be Solved by the Present Disclosure

It is desired that a hollow extrusion-molded material, a heat-shrinkable tube and the like used for the above-described applications have various properties described below.

For example, a hollow extrusion-molded material and a heat-shrinkable tube used to form insulated covering of an insulated electric wire used in electronics, electronic devices, communication and the like are required to have flame retardancy that passes the vertical burning test (VW-1) defined by the UL standards. Thus, the bromine-based flame retardant, the antimony trioxide and the magnesium hydroxide are blended, as a flame retardant, into the resin composition that forms the hollow extrusion-molded material described in each of PTLs 1 to 3.

Furthermore, it is desired that the hollow extrusion-molded material and the heat-shrinkable tube used to form insulated covering of the insulated electric wire have excellent mechanical strength such as tensile strength and tensile elongation. Thus, as described in PTL 2, the EVA-based resin composition is often used for formation. However, when the EVA-based resin composition is used, the hollow extrusion-molded material and the heat-shrinkable tube generate an acetic acid odor, and the heat aging resistance is insufficient.

When the ethylene-ethyl acrylate copolymer (EEA)-based resin composition described in PTL 3 is used instead of the EVA-based resin composition, a tube having excellent mechanical strength can be obtained and generation of an acetic acid odor can be prevented.

However, when the hollow extrusion-molded material is formed by extrusion molding, the melted resin composition yields to the pulling force and elongates because there is no support. Therefore, drawdown molding, which is a method for performing molding by active drawdown and elongation, is performed. However, when drawdown molding is performed using the EEA-based resin composition, there arises such a problem that a die residue (adhering substance) occurs around a die mouthpiece of a molding machine and adheres to the molded product, i.e., the tube, which leads to deterioration of an appearance of the tube and deterioration of commodity value of the product.

The above-described problem is prominent, particularly when a line speed (extrusion speed of the melted resin composition) during drawdown molding is high, or when a thickness (thickness of a resin film that forms the tube) of the hollow extrusion-molded material is thin.

An object of the present disclosure is to provide a hollow extrusion-molded material having flame retardancy that passes the VW-1 burning test, having excellent mechanical strength such as tensile strength and tensile elongation, not causing an odor problem such as generation of an acetic acid odor, reducing occurrence of a die residue during drawdown molding, and having an excellent tube appearance. The object of the present disclosure is to also provide a crosslinked polymer of the hollow extrusion-molded material, and a heat-shrinkable tube and a multilayer heat-shrinkable tube obtained from the crosslinked polymer.

As a result of study, the present inventors found that a hollow extrusion-molded material formed by drawdown molding of a resin composition, and a heat-shrinkable tube manufactured from the hollow extrusion-molded material have flame retardancy that passes the VW-1 burning test and excellent mechanical strength, and does not cause an odor problem, the resin composition including, as a base resin, EEA, or EEA and linear low-density polyethylene (LLDPE) in which a composition ratio (mass ratio) between EEA and LLDPE is within a particular range, and including, as a flame retardant, a bromine-based flame retardant, antimony trioxide and magnesium hydroxide within a particular composition ratio (mass ratio) range. The present inventors also found that occurrence of a die residue during extrusion molding is reduced and a hollow extrusion-molded material having an excellent appearance is obtained even when an extrusion speed (line speed) of the melted resin composition during extrusion molding (drawdown molding) is high or even when a thickness of the hollow molded material is thin. Thus, the present inventors completed the present invention.

### Advantageous Effect of the Present Disclosure

The hollow extrusion-molded material according to the first aspect of the present disclosure has flame retardancy that passes the VW-1 burning test, does not cause an odor problem such as generation of an acetic acid odor, and has an excellent appearance even when a line speed during extrusion molding is high or even when a thickness of the hollow molded material is thin, because deterioration of the appearance caused by drawdown molding is reduced.

The crosslinked polymer according to the second aspect of the present disclosure, the heat-shrinkable tube according to the third aspect of the present disclosure, and the multilayer heat-shrinkable tube according to the fourth aspect of the present disclosure have flame retardancy that passes the VW-1 burning test, have excellent mechanical strength such as tensile strength and tensile elongation, does not cause an odor problem such as generation of an acetic acid odor, and has an excellent appearance even when a line speed during extrusion molding is high or even when a thickness of the hollow molded material is thin, because deterioration of the appearance caused by drawdown molding is reduced.

By covering an object to be covered with the multilayer heat-shrinkable tube according to the fourth aspect of the present disclosure and performing heat shrinkage, the covering having excellent adhesiveness to the object to be covered can be obtained.

### Description of Embodiments

Hereinafter, embodiments for implementing the present disclosure will be specifically described. The present disclosure is not limited to the embodiments described below and is intended to include any modifications within the scope of the terms of the claims and within the scope and meaning equivalent to the terms of the claims.

A hollow extrusion-molded material according to the first aspect of the present disclosure is a hollow extrusion-molded material fabricated by drawdown molding of a resin composition, the resin composition including a base resin composed of EEA, or EEA and LLDPE, the resin composition further including a bromine-based flame retardant, antimony trioxide and magnesium hydroxide. In the hollow extrusion-molded material, a composition ratio (mass ratio) between the EEA and the LLDPE is within a range of 100:0 to 85:15, and with respect to 100 parts by mass of the base resin, a content of the bromine-based flame retardant is not less than 55 parts by mass and less than 90 parts by mass, a content of the antimony trioxide is less than 15 parts by mass, and a content of the magnesium hydroxide is less than 50 parts by mass. Furthermore, the magnesium hydroxide has an average particle size of not less than 0.5 μm and not more than 3.0 μm.

The base resin of the hollow extrusion-molded material according to the first aspect is composed only of the EEA or composed of the EEA and the LLDPE, and does not substantially include EVA. Therefore, an odor problem such as generation of an acetic acid odor does not occur. In addition, the hollow extrusion-molded material according to the first aspect includes the bromine-based flame retardant, the antimony trioxide and the magnesium hydroxide within the above-described composition ratio range, and thus, has flame retardancy that passes the VW-1 burning test.

When the EEA is included as the base resin, and the bromine-based flame retardant, the antimony trioxide and the magnesium hydroxide are blended as a flame retardant, and drawdown molding is performed, there arises a problem of occurrence of a die residue, which leads to deterioration of an appearance of a tube. The above-described problem tends to occur particularly when a line speed during extrusion molding is high or when a thickness of the hollow molded material is thin. However, in the hollow extrusion-molded material according to the first aspect, the composition ratio between the EEA and the LLDPE is set within the particular range, the contents of the bromine-based flame retardant, the antimony trioxide and the magnesium hydroxide are set within the particular ranges, and the magnesium hydroxide having the average particle size within the particular range is used. Therefore, the hollow extrusion-molded material having an excellent appearance is obtained even when the line speed during extrusion molding is high or even when the thickness of the hollow molded material is thin, because deterioration of the appearance of the tube caused by occurrence of the die residue is reduced.

Specifically, when the resin composition that forms the hollow extrusion-molded material according the above-described first aspect is subjected to drawdown molding, the die residue does not occur even when a shear speed of drawdown molding is a high line speed of higher than 800 s⁻¹ and not higher than 5000 s⁻¹ and even when the thickness is not less than 0.6 mm and not more than 0.9 mm. That is, the first aspect provides the hollow extrusion-molded material subjected to drawdown molding at a shear speed of not higher than 5000 s⁻¹, and further provides the hollow extrusion-molded material having a thickness of not less than 0.6 mm and not more than 0.9 mm and subjected to drawdown molding at a shear speed of not higher than 5000 s⁻¹. The shear speed is a value indicated by r in the following equation, where D_{D} represents a die inner diameter (mm) of a tubing die used for drawdown molding, and Dr represents a chip outer diameter (mm):

H=(D_{D}−Dr)/2 (mm), W=7T(D_{D}+Dr)/2 (mm), r=6q/WH² (q represents a volumetric flow rate (mm²/sec)).

(Base Resin)

The base resin forms a resin component of the above-described resin composition. The resin component may be composed only of the base resin, or may include the base resin as a maximum component and include other resins that do not impair the gist of the invention.

The EEA that forms the base resin is a copolymer of ethylene and ethyl acrylate. Although a range of a copolymerization ratio between ethylene and ethyl acrylate is not particularly limited, EEA in which a mass ratio of the ethyl acrylate in all constituent monomers is approximately 5 to 25% is normally used. As the ratio of the ethyl acrylate increases, a melting point decreases. EEA having a melting point of 83 to 107° C. is normally used.

Although a range of a molecular weight and a range of a density (specific gravity) of the EEA are not particularly limited, either, EEA having a melt flow rate (MFR) of 0.3 g/10 min to 25 g/10 min and a specific gravity of 0.92 to 0.95 is normally used, the melt flow rate being measured at 190° C. and a load of 21.6 kg.

The LLDPE that forms the base resin is normally a thermoplastic resin formed by copolymerization of repeating units of ethylene with only a small amount of α-olefin, and a specific gravity thereof is within a range of approximately 0.910 to 0.925 (JIS K6899-1:2000). LLDPE having approximately 10 to 30 short branches (SCBs) with respect to 1000 ethylene monomers is normally used. Examples of the α-olefin copolymerized with the ethylene include 1-butene, 1-hexene, 4-methylpentene-1, 1-octene and the like. A molecular weight of the LLDPE, a type and a copolymerization ratio of the α-olefin, the number of SCBs, and the like are not particularly limited.

A composition ratio of the EEA in the base resin is not less than 85 mass % with respect to a total mass of the EEA and the LLDPE. The base resin may be composed only of the EEA without including the LLDPE. When the composition ratio of the EEA is less than 85 mass % (when a composition ratio of the LLDPE exceeds 15 mass %), a die residue is likely to occur during drawdown molding. Particularly, when the line speed during extrusion molding is not lower than 800 su or when the thickness of the hollow molded material is not more than 0.9 mm, a die residue is likely to occur and the hollow extrusion-molded material having an excellent appearance is not obtained.

(Bromine-Based Flame Retardant)

The bromine-based flame retardant refers to a brominated aromatic compound, a brominated aliphatic compound, a brominated aromatic aliphatic compound, a brominated alicyclic compound or the like.

Specifically, examples of the bromine-based flame retardant can include decabromodiphenyl ether, hexabromobenzene, ethylenebistetrabromophthalimide, 2,2-bis(4-bromoethyl ether-3,5-dibromophenyl)propane, ethylenebis-dibromonorbornanedicarboximide, tetrabromo-bisphenol S, tris(2,3-dibromopropyl-1)isocyanurate, hexabromocyclododecane (HBCD), octabromophenyl ether, tetrabromobisphenol A (TBA) epoxy oligomer or polymer, TBA-bis(2,3-dibromopropyl ether), polydibromophenylene oxide, bis(tribromophenoxy)ethane, ethylenebis-pentabromobenzene, dibromoethyl-dibromocyclohexane, dibromoneopentyl glycol, tribromophenol, tribromophenol allyl ether, tetra-decabromo-diphenoxybenzene, 1,2-bis(2,3,4,5,6-pentabromophenyl)ethane, 2,2-bis(4-hydroxy-3,5-dibromophenyl)propane, 2,2-bis(4-hydroxyethoxy-3,5-dibromophenyl)propane, pentabromophenol, pentabromotoluene, pentabromodiphenyl oxide, hexabromodiphenyl ether, octabromodiphenyl ether, octabromodiphenyl oxide, dibromoneopentylglycol tetracarbonate, bis(tribromophenyl)fumaramide, N-methylhexabromophenylamine and the like. These can be used alone, or two or more of these can be mixed and used.

Among the above-described examples of the bromine-based flame retardant, 1,2-bis(2,3,4,5,6-pentabromophenyl)ethane is preferable.

(Magnesium Hydroxide)

The magnesium hydroxide blended into the resin composition has an average particle size of not less than 0.5 μm and not more than 3.0 μm, the average particle size being obtained through particle size distribution measurement by a laser diffraction method. When magnesium hydroxide having an average particle size larger than 3.0 μm is used, a die residue is likely to occur during drawdown molding, and thus, the hollow extrusion-molded material having an excellent appearance is not obtained. On the other hand, when magnesium hydroxide having an average particle size smaller than 0.5 μm is used, aggregation caused by poor dispersion occurs and a die residue is likely to occur during drawdown molding, and thus, the hollow extrusion-molded material having an excellent appearance is not obtained.

More preferably, magnesium hydroxide having an average particle size of not less than 0.7 μm and not more than 2.0 μm is used. As a result, occurrence of a die residue during drawdown molding is further reduced, and thus, the hollow extrusion-molded material having a more excellent appearance is obtained.

(Contents of Bromine-Based Flame Retardant, Antimony Trioxide and Magnesium Hydroxide)

In order to obtain sufficient flame retardancy even when the thickness of the hollow extrusion-molded material is thin, it is necessary to increase an amount of the flame retardant, and particularly the bromine-based flame retardant. In order to obtain the flame retardancy that passes the VW-1 burning test even when the thickness is 0.6 mm, it is required to include, in the resin composition, not less than 55 parts by mass of the bromine-based flame retardant with respect to 100 parts by mass of the base resin.

As the amount of the flame retardant increases, a die residue is more likely to occur during drawdown molding. As a result of study, the present inventors found that when the content of the bromine-based flame retardant is not less than 55 parts by mass and less than 90 parts by mass with respect to 100 parts by mass of the base resin, the flame retardancy that passes the VW-1 burning test can be obtained, and occurrence of a die residue during drawdown molding is reduced and thus the hollow extrusion-molded material having an excellent appearance is obtained, even if the contents of the antimony trioxide and the magnesium hydroxide are less than 15 parts by mass and less than 50 parts by mass, respectively, with respect to 100 parts by mass of the base resin.

When the content of the antimony trioxide is not less than 15 parts by mass with respect to 100 parts by mass of the base resin or when the content of the magnesium hydroxide is not less than 50 parts by mass with respect to 100 parts by mass of the base resin, a die residue is likely to occur during drawdown molding, which leads to deterioration of an appearance of a tube.

The content of the magnesium hydroxide is preferably not less than 10 parts by mass and less than 50 parts by mass, and more preferably not less than 10 parts by mass and not more than 40 parts by mass, with respect to 100 parts by mass of the base resin. When the content of the magnesium hydroxide is not less than 10 parts by mass, the flame retardancy is further improved and the flame retardancy that passes the VW-1 burning test more reliably can be obtained. When the content of the magnesium hydroxide exceeds 40 parts by mass, the mechanical strength such as tensile strength and tensile elongation of the hollow extrusion-molded material tends to decrease. Therefore, the content of the magnesium hydroxide is preferably not more than 40 parts by mass.

In addition, when the content of the bromine-based flame retardant is not less than 90 parts by mass with respect to 100 parts by mass of the base resin, not only a die residue is likely to occur during drawdown molding, but also the mechanical strength such as tensile strength and tensile elongation decreases. Furthermore, in order to obtain the flame retardancy that passes the VW-1 burning test more reliably even when the thickness is thin, the content of the bromine-based flame retardant is preferably not less than 65 parts by mass with respect to 100 parts by mass of the base resin.

(Non-Essential Component)

In addition to the above-described essential components, the resin composition that forms the hollow extrusion-molded material according to the present aspect may include, as needed, a resin other than the EEA and the LLDPE, and an additive other than the bromine-based flame retardant, the antimony trioxide and the magnesium hydroxide that do not impair the gist of the invention. Examples of the other additive can include an antioxidant, a copper inhibitor, a lubricant, a coloring agent, a thermal stabilizer, an ultraviolet absorber and the like. For example, when the hollow extrusion-molded material, the crosslinked polymer thereof and the like are used for insulated covering of an insulated electric wire, the antioxidant is preferably added to prevent deterioration over time. Examples of the antioxidant can include an amine-based antioxidant such as a polymer of 4,4′-dioctyl diphenylamine, N,N′-diphenyl-p-phenylenediamine or 2,2,4-trimethyl-1,2-dihydroquinoline, a phenol-based antioxidant such as pentaerythrityl-tetrakis(3-(3,5-di-t-butyl-4-hydroxyphenyl)propionate), octadecyl-3-(3,5-di-t-butyl-4-hydroxyphenyl)propionate or 1,3,5-trimethyl-2,4,6-tris(3,5-di-t-butyl-4-hydroxybenzyl)benzene, a sulfur-based antioxidant such as bis(2-methyl-4-(3-n-alkylthiopropionyloxy)-5-t-butylphenyl)sulfide, 2-mercaptobenzimidazole and a zinc salt thereof, or pentaerythritol-tetrakis(3-lauryl-thiopropionate), and the like.

A crosslinking aid may also be included to promote crosslinking.

(Method for Manufacturing Hollow Extrusion-Molded Material)

The hollow extrusion-molded material according to the first aspect can be manufactured by melting and kneading the above-described essential components and the other components blended as needed with a known kneading apparatus such as a two-axis kneading extruder, a Banbury mixer, a kneader, and a roll to thereby obtain a kneaded product, and tubularly molding the obtained kneaded product with a die (tubing die) having a tubular mouthpiece (resin discharge hole) in a known extrusion molding machine. As described above, tubularly molding is normally performed by drawdown molding. Therefore, the hollow extrusion-molded material according to the first aspect is normally a drawdown-molded material. Drawdown molding herein refers to a molding method for molding an extruded molded material while elongating the extruded molded material in a direction of extrusion.

The second aspect of the present disclosure provides a crosslinked polymer of a hollow extrusion-molded material formed by crosslinking the above-described base resin of the hollow extrusion-molded material according to the above-described first aspect. By crosslinking the base resin of the hollow extrusion-molded material, it is possible to obtain the tube-like crosslinked polymer having excellent mechanical strength such as tensile strength and tensile elongation, while maintaining the above-described excellent property of the hollow extrusion-molded material. In addition, by enlarging a diameter of the obtained tube-like crosslinked polymer, the heat-shrinkable tube according to the third aspect can be manufactured.

(Crosslinking)

Examples of a method for crosslinking the base resin of the hollow extrusion-molded material include methods such as crosslinking by irradiation with ionizing radiation, chemical crosslinking and thermal crosslinking. From the perspective of ease of implementation and the like, crosslinking by irradiation with ionizing radiation is preferable. Examples of the ionizing radiation include a particle beam such as an α beam, a β beam and an electron beam, a high-energy electromagnetic wave such as an X ray and a γ ray, and the like. However, from the perspective of ease of control, safety and the like, the electron beam is preferably used.

Although an irradiation dose of the ionizing radiation is not particularly limited, it is preferable to select an irradiation dose that provides a sufficient crosslinking density and a low degree of deterioration of the resin caused by irradiation.

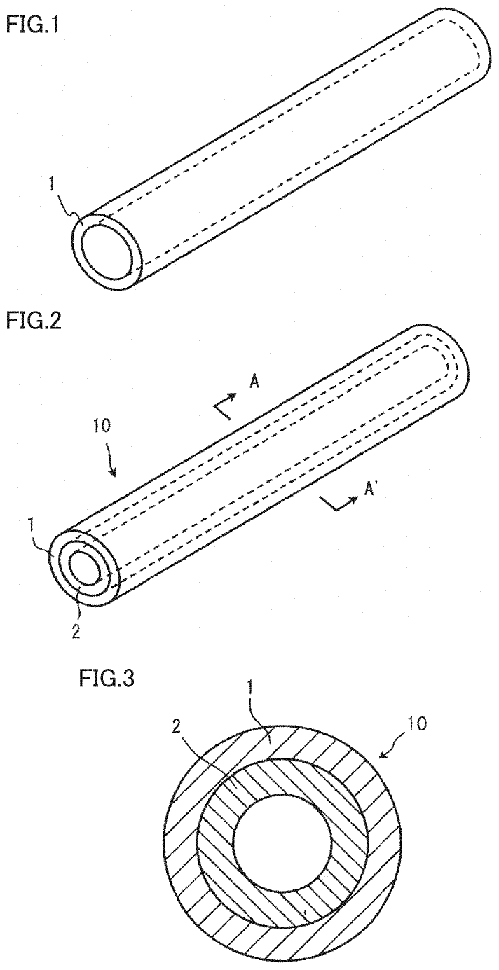

The third aspect of the present disclosure provides a heat-shrinkable tube 1 which is a diameter-enlarged type of the crosslinked polymer of the hollow extrusion-molded material according to the above-described second embodiment, as shown in FIG. 1. The diameter-enlarged type of the crosslinked polymer of the hollow extrusion-molded material refers to a tube formed by enlarging a diameter of and providing heat shrinkability to the crosslinked polymer of the hollow extrusion-molded material. Heat-shrinkable tube 1 according to the third aspect has the above-described excellent property of the crosslinked polymer of the hollow extrusion-molded material according to the second aspect, and has excellent mechanical strength such as tensile strength and tensile elongation, while maintaining the above-described excellent property of the hollow extrusion-molded material according to the first aspect.

(Diameter Enlargement)

Heat-shrinkable tube 1 according to the third embodiment is manufactured by enlarging the diameter of and providing heat shrinkability to the crosslinked polymer of the hollow extrusion-molded material according to the above-described second aspect. Diameter enlargement can be performed using a method for expanding the crosslinked polymer (tube-like crosslinked polymer) of the hollow extrusion-molded material according to the second aspect to have a prescribed inner diameter, with the crosslinked polymer heated to a temperature equal to or higher than a melting point thereof, and then, cooling the crosslinked polymer to fix a shape thereof. Expansion of the tube-like crosslinked polymer can be performed using, for example, a method for introducing the compressed air into the tube-like crosslinked polymer. Diameter enlargement is normally performed such that an inner diameter is enlarged to approximately one and a half times to four times as large as the original inner diameter.

Heat-shrinkable tube 1 according to the third aspect is used for insulated covering of an insulated electric wire, and protection, waterproofing, corrosion protection and the like of a bundling portion of an electric wire, a bundling portion of an electric wire, and an end portion of a wiring.

The fourth aspect of the present disclosure provides a multilayer heat-shrinkable tube 10 having heat-shrinkable tube 1 according to the above-described third aspect, and an adhesive layer 2 disposed on an inner circumferential surface of the above-described heat-shrinkable tube and including a hot melt resin, as shown in FIGS. 2 and 3.

Since multilayer heat-shrinkable tube 10 has an outer layer formed of heat-shrinkable tube 1 according to the above-described third aspect, multilayer heat-shrinkable tube 10 has an excellent property similar to that of heat-shrinkable tube 1 according to the third aspect. Furthermore, since adhesive layer 2 including the hot melt resin is formed on the inner circumferential surface of the heat-shrinkable tube, the adhesive layer flows along a shape of a covered portion during heat shrinkage, and thus, the adhesiveness to the portion can be improved and protection, waterproofing and corrosion protection of the portion can be achieved more reliably.

(Method for Manufacturing Multilayer Heat-Shrinkable Tube According to Fourth Aspect)

Multilayer heat-shrinkable tube 10 can be manufactured using:

1) a method for tubularly molding the hot melt resin to thereby fabricate a tube, and causing an outer circumferential surface thereof to adhere to the inner circumferential surface of the heat-shrinkable tube according to the third aspect fabricated as described above;

2) a method for tubularly molding the hot melt resin to thereby fabricate a tube, causing an outer circumferential surface thereof to adhere to the inner circumferential surface of the crosslinked polymer of the hollow extrusion-molded material according to the second aspect fabricated as described above, and then, performing diameter enlargement as described above;

3) a method for simultaneously extruding (co-extruding) the resin composition that forms the hollow extrusion-molded material according to the first embodiment and the hot melt resin that forms the adhesive layer such that the adhesive layer is located inside, and then, performing crosslinking and diameter enlargement as described above; and the like.

(Hot Melt Resin)

As the hot melt resin which is a material for forming adhesive layer 2, a resin that has an adhesive property, allows tubularly molding, does not deform and flow during storage at room temperature, and melts and flows at a temperature during heat shrinkage is desirably used, and the hot melt resin can be selected from the existing hot melt resins having these properties. Specifically, EVA, a polyamide resin, a polyester resin or the like can be used as the hot melt resin. Among these, one or more types of resins selected from the group consisting of EVA and a polyamide resin are preferably used because the resins adhere to a wide range of different materials such as metal, polyvinyl chloride and polyethylene that may be adherends of the heat-shrinkable tube. When the heat-shrinkable tube is formed from the EVA-based resin composition, an acetic acid odor is generated during molding (drawdown molding) of the heat-shrinkable tube. However, since a temperature of the heat-shrinkable tube during heat shrinkage is lower than a temperature of the heat-shrinkable tube during molding, the odor problem hardly occurs even when adhesive layer 2 is formed using EVA as the hot melt resin.

In addition to the hot melt resin, other additives and the like that do not impair the gist of the invention may be blended into adhesive layer 2 as needed. Examples of the other additives can include an antioxidant, a copper inhibitor, a deterioration inhibitor, a viscosity property improver, a flame retardant, a lubricant, a coloring agent, a thermal stabilizer, an ultraviolet absorber, a viscous agent and the like.

(Applications of Multilayer Heat-Shrinkable Tube According to Fourth Aspect)

The adhesive layer including the resin that has an adhesive property and melts and flows at a temperature during heat shrinkage is disposed on the inner circumferential side of multilayer heat-shrinkable tube 10, and thus, the excellent adhesiveness to a covered portion of an object to be covered is obtained during heat shrinkage. Thus, multilayer heat-shrinkable tube 10 is suitably used for insulated covering of an insulated electric wire, and protection, waterproofing and corrosion protection of a bundling portion of an electric wire and an end portion of a wiring.

### Examples

1) Materials Used in Experimental Examples

(EEA)
EEA1 amount of EA (ethyl acrylate): 18 wt %, MFR=6, melting point: 93° C.
EEA2 amount of EA: 15 wt %, MFR=0.8, melting point: 100° C.
EEA3 amount of EA: 20 wt %, MFR=5, melting point: 96° C.

(LLDPE)
LLDPE1 MFR=0.7, density: 0.92 g/mL

(EVA)
EVA1 amount of VA: 17 wt %, MFR=0.8, melting point: 89° C.

(Flame Retardant)
bromine-based flame retardant (ethylene-1,2-bis(pentabromophenyl))
antimony trioxide
magnesium hydroxide 1 average particle size: 0.8 μm, BET specific surface area: 6.0 m²/g, untreated (“untreated” means not treated with a stearic acid and the like, and the same applies to the following description)
magnesium hydroxide 2 average particle size: 0.8 μm, BET specific surface area: 6.0 m²/g, treated with a stearic acid
magnesium hydroxide 3 average particle size: 1.7 μm, BET specific surface area: 2.7 m²/g, untreated
magnesium hydroxide 4 average particle size: 7.0 μm, BET specific surface area: 35 m²/g, untreated

(Other Additives)

In a formula in each of Experimental Examples 1 to 20, 4 parts by mass of the antioxidant was added with respect to 100 parts by mass of the base resin, in addition to the above-described materials.

2) Manufacturing of Electric Wire and Presence or Absence of Substance Adhering to Die Portion

A resin composition including the materials shown in 1) above in accordance with each formula (parts by mass) shown in Tables 1 to 4 was melted and kneaded, and then, the resin composition was extrusion-molded (full extruded) from a mouthpiece of a die onto an outer circumference of an electric wire (0.8 ta wire) at a line speed of 20 m/min using a 50 mmφ single-axis extruder, to thereby form a cover layer having a thickness of 1 mmt. The mouthpiece portion of the die was visually checked to evaluate the presence or absence of a substance adhering to the die portion in accordance with the following criteria. The result was shown in the “Presence or absence of substance adhering to die portion: in manufacturing of electric wire” column in Tables 1 to 4.

(Evaluation Criteria)

A: No die residue was visually checked.

B: A die residue was visually checked after 10 or more minutes elapsed since the start of extrusion.

C: A die residue was visually checked before 10 minutes elapsed since the start of extrusion.

3) Manufacturing of Tube and Presence or Absence of Substance Adhering to Die Portion

3-1) A resin composition including the materials shown in 1) above in accordance with each formula (parts by mass) shown in Tables 1 to 4 was melted and kneaded, and then, the resin composition was drawdown-molded from a mouthpiece of a die (die inner diameter: 10 mm, chip outer diameter: 6.65 mm) at a line speed of 20 m/min (shear speed: 599 s⁻¹) and at a drawdown rate of 2.0 using a 50 mmφ single-axis extruder, to thereby fabricate a tube (hollow extrusion-molded material) having an outer diameter of 8.0 mmφ, an inner diameter of 6.0 mmφ and a thickness of 1 mmt.

The drawdown rate is a value obtained from [(mouthpiece diameter)²−(mandrel outer diameter)²]/[(tube outer diameter)²−(tube inner diameter)²]. The same applies to the following description.

3-2) Drawdown molding was performed similarly to 3-1) above, except that the line speed was set at 100 m/min (shear speed: 2997 s⁻¹), to thereby fabricate a tube (hollow extrusion-molded material) having an outer diameter of 8.0 mmφ, an inner diameter of 6.0 mmφ and a thickness of 1 mmt.

3-3) Drawdown molding was performed under conditions (line speed: 20 m/min (shear speed: 717 s⁻¹)) similar to those of 3-1) above, except that a mouthpiece of a die having a die inner diameter of 9.4 mm and a chip outer diameter of 6.65 mm was used, to thereby fabricate a tube (hollow extrusion-molded material) having an outer diameter of 7.6 mmφ, an inner diameter of 6.0 mmφ and a thickness of 0.8 mmt.

3-4) Drawdown molding was performed under conditions (line speed: 100 m/min (shear speed: 3585 s⁻¹)) similar to those of 3-2) above, except that a mouthpiece of a die having a die inner diameter of 9.4 mm and a chip outer diameter of 6.65 mm was used, to thereby fabricate a tube (hollow extrusion-molded material) having an outer diameter of 7.6 mmφ, an inner diameter of 6.0 mmφ and a thickness of 0.8 mmt.

3-5) Drawdown molding was performed under conditions (line speed: 20 m/min (shear speed: 868 s⁻¹)) similar to those of 3-1) above, except that a mouthpiece of a die having a die inner diameter of 9 mm and a chip outer diameter of 6.65 mm was used, to thereby fabricate a tube (hollow extrusion-molded material) having an outer diameter of 7.4 mmt, an inner diameter of 6.0 mmφ and a thickness of 0.7 mmt.

3-6) Drawdown molding was performed under conditions (line speed: 100 m/min (shear speed: 4341 s⁻¹)) similar to those of 3-2) above, except that a mouthpiece of a die having a die inner diameter of 9 mm and a chip outer diameter of 6.65 mm was used, to thereby fabricate a tube (hollow extrusion-molded material) having an outer diameter of 7.4 mmφ, an inner diameter of 6.0 mmφ and a thickness of 0.7 mmt.

As to each of 3-1) to 3-6) above, the mouthpiece portion of the die after fabrication (after drawdown molding) of the tube (hollow extrusion-molded material) was visually checked to evaluate the presence or absence of a substance adhering to the die portion in accordance with the criteria identical to the criteria shown in the above-described “Manufacturing of electric wire and presence or absence of substance adhering to die portion” section. The result was shown in the “Presence or absence of substance adhering to die portion: in manufacturing of tube” column (column corresponding to each line speed and thickness) in Tables 1 to 4.

4) VW-1 Burning Test

The tube manufactured in 3-1), 3-3) or 3-5) above (in each case, the line speed was 20 m/min) was irradiated with an electron beam at a dose of 200 kGy, to thereby fabricate five samples. Each of the five samples fabricated as described above was subjected to the VW-1 vertical flame retardant test described in the UL standards. Specifically, “pass” indicated that when each sample was flamed by a burner at an angle of 20 degrees, and ignition for 15 seconds and pause for 15 seconds are repeated five times, the fire was extinguished within 60 seconds, the absorbent cotton laid under each sample did not burn by burning fallen objects, and the kraft paper attached to the top of each sample did not burn or scorch. A case in which all of the five samples passed the test was defined as “pass”, and a case in which even one of the five samples did not pass the test was defined as “fail”. The result was shown in the “VW-1 burning test” column (column corresponding to each thickness) in Tables 1 to 4.

5) Tensile Strength and Tensile Elongation

The tube manufactured in 3-1) above was irradiated with an electron beam at a dose of 200 kGy, to thereby fabricate a sample. The fabricated sample was pulled at 500 mm/min using the method defined in JIS C3005 (2014), to measure a tensile strength and a tensile elongation. The measurement result was shown in the “Tensile strength” column and the “Tensile elongation” column (in the column of the evaluation result for the thickness of 1 mm) in Tables 1 to 4.

6) Odor

The tube manufactured in 3-1) above was irradiated with an electron beam at a dose of 200 kGy, to thereby fabricate a sample. The fabricated sample was cut to have a length of 5 cm, put into a test tube and left for one day at room temperature with a lid closed. Thereafter, the lid of the test tube was removed and the sample was smelled, to thereby determine whether or not the sample had an irritating odor. The above-described determination was made by three different people. A case in which even one person felt the irritating odor was defined as “fail”, and a case in which no one felt the irritating odor was defined as “pass”. The result was shown in the “Odor” column (in the column of the evaluation result for the thickness of 1.0 mm) in Tables 1 to 4.

TABLE 1

| | | Experimental | Experimental | Experimental | Experimental | Experimental |
|---|---|---|---|---|---|---|
| | | Example 1 | Example 2 | Example 3 | Example 4 | Example 5 |
| Base resin | EEA1 | 100 | 100 | 100 | 85 | — |
| | EEA2 | — | — | — | — | 100 |
| | EEA3 | — | — | — | — | — |
| | LLDPE1 | — | — | — | 15 | — |
| | EVA1 | — | — | — | — | — |
| Flame | bromine-based flame | 80 | 80 | 80 | 80 | 80 |
| retardant | retardant | | | | | |
| | antimony trioxide | 5 | 5 | 5 | 5 | 5 |
| | magnesium hydroxide 1 | 30 | — | — | 30 | 30 |
| | magnesium hydroxide 2 | — | 30 | — | — | — |
| | magnesium hydroxide 3 | — | — | 30 | — | — |
| | magnesium hydroxide 4 | — | — | — | — | — |

Evaluation result of hollow extrusion-molded material having a thickness of 1.0 mm

| Tensile strength (MPa) | | 12.4 | 122 | 12.1 | 11.8 | 11.8 |
|---|---|---|---|---|---|---|
| Tensile elongation (%) | | 580 | 550 | 540 | 440 | 510 |
| Odor | | pass | pass | pass | pass | pass |
| Presence or | in manufacturing | A | A | A | A | A |
| absence of | of electric wire | | | | | |
| substance | (20 m/min) | | | | | |
| adhering to | in manufacturing of | A | A | A | A | A |
| die portion | tube (20 m/min) | | | | | |
| | in manufacturing of | A | A | A | A | A |
| | tube (100 m/min) | | | | | |

| | | | | | |
|---|---|---|---|---|---|
| VW-1 burning test | pass | pass | pass | pass | pass |

Evaluation result of hollow extrusion-molded material having a thickness of 0.8 mm

| | | | | | | |
|---|---|---|---|---|---|---|
| Presence or | in manufacturing of | A | A | A | A | A |
| absence of | tube (20 m/min) | | | | | |
| substance | in manufacturing of | A | A | A | A | A |
| adhering to | tube (100 m/min) | | | | | |
| die portion | | | | | | |

| | | | | | |
|---|---|---|---|---|---|
| VW-1 burning test | pass | pass | pass | pass | pass |

Evaluation result of hollow extrusion-molded material having a thickness of 0.7 mm

| | | | | | | |
|---|---|---|---|---|---|---|
| Presence or | in manufacturing of | A | A | A | A | A |
| absence of | tube (20 m/min) | | | | | |
| substance | in manufacturing of | A | A | A | A | A |
| adhering to | tube (100 m/min) | | | | | |
| die portion | | | | | | |

| | | | | | |
|---|---|---|---|---|---|
| VW-1 burning test | pass | pass | pass | pass | pass |

TABLE 2

| | | Experimental | Experimental | Experimental | Experimental | Experimental | Experimental |
|---|---|---|---|---|---|---|---|
| | | Example 6 | Example 7 | Example 8 | Example 9 | Example 10 | Example 11 |
| Base resin | EEA1 | — | 100 | 85 | 100 | 100 | 80 |
| | EEA2 | — | — | — | — | — | — |
| | EEA3 | 100 | — | — | — | — | — |
| | LLDPE1 | — | — | 15 | — | — | 20 |
| | EVA1 | — | — | — | — | — | — |
| Flame | bromine-based flame | 80 | 90 | 90 | 55 | 80 | 80 |
| retardant | retardant | | | | | | |
| | antimony trioxide | 5 | 15 | 15 | — | 5 | 5 |
| | magnesium hydroxide 1 | 30 | 50 | 50 | 50 | 10 | 30 |
| | magnesium hydroxide 2 | — | — | — | — | — | — |
| | magnesium hydroxide 3 | — | — | — | — | — | — |
| | magnesium hydroxide 4 | — | — | — | — | — | — |

Evaluation result of hollow extrusion-molded material having a thickness of 1.0 mm

| Tensile strength (MPa) | | 125 | 105 | 102 | 10.7 | 13.1 | 9.9 |
|---|---|---|---|---|---|---|---|
| Tensile elongation (%) | | 610 | 420 | 360 | 400 | 670 | 330 |
| Odor | | pass | pass | pass | pass | pass | pass |
| Presence or | in manufacturing | A | A | A | A | A | A |
| absence of | of electric wire | | | | | | |
| substance | (20 m/min) | | | | | | |
| adhering to | in manufacturing of | A | A | A | A | A | A |
| die portion | tube (20 m/min) | | | | | | |
| | in manufacturing of | A | A | A | A | A | B |
| | tube (100 m/min) | | | | | | |

| | | | | | | |
|---|---|---|---|---|---|---|
| VW-1 burning test | pass | pass | pass | pass | pass | pass |

Evaluation result of hollow extrusion-molded material having a thickness of 0.8 mm

| | | | | | | | |
|---|---|---|---|---|---|---|---|
| Presence or | in manufacturing of | A | A | A | A | A | A |
| absence of | tube (20 m/min) | | | | | | |
| substance | in manufacturing of | A | A | A | A | A | C |
| adhering to | tube (100 m/min) | | | | | | |
| die portion | | | | | | | |

| | | | | | | |
|---|---|---|---|---|---|---|
| VW-1 burning test | pass | pass | pass | pass | pass | pass |

Evaluation result of hollow extrusion-molded material having a thickness of 0.7 mm

| | | | | | | | |
|---|---|---|---|---|---|---|---|
| Presence or | in manufacturing of | A | A | A | A | A | B |
| absence of | tube (20 m/min) | | | | | | |
| substance | in manufacturing of | A | A | A | A | A | C |
| adhering to | tube (100 m/min) | | | | | | |
| die portion | | | | | | | |

| | | | | | | |
|---|---|---|---|---|---|---|
| VW-1 burning test | pass | pass | pass | pass | pass | fail |

TABLE 3

| | | Experimental | Experimental | Experimental | Experimental | Experimental |
|---|---|---|---|---|---|---|
| | | Example 12 | Example 13 | Example 14 | Example 15 | Example 16 |
| Base resin | EEA1 | 70 | 100 | 100 | 100 | 100 |
| | EEA2 | — | — | — | — | — |
| | EEA3 | — | — | — | — | — |
| | LLDPE1 | 30 | — | — | — | — |
| | EVA1 | — | — | — | — | — |
| Flame | bromine-based flame | 40 | 40 | 50 | 90 | 60 |
| retardant | retardant | | | | | |
| | antimony trioxide | 20 | 20 | 25 | 20 | 30 |
| | magnesium hydroxide 1 | 30 | 30 | 30 | 50 | 30 |
| | magnesium hydroxide 2 | — | — | — | — | — |
| | magnesium hydroxide 3 | — | — | — | — | — |
| | magnesium hydroxide 4 | — | — | — | — | — |

Evaluation result of hollow extrusion-molded material having a thickness of 1.0 mm

| Tensile strength (MPa) | | 13.8 | 125 | 112 | 7.4 | 9.8 |
|---|---|---|---|---|---|---|
| Tensile elongation (%) | | 410 | 460 | 370 | 280 | 280 |
| Odor | | pass | pass | pass | pass | pass |
| Presence or | in manufacturing | A | A | A | A | A |
| absence of | of electric wire | | | | | |
| substance | (20 m/min) | | | | | |
| adhering to | in manufacturing of | A | A | A | B | C |
| die portion | tube (20 m/min) | | | | | |
| | in manufacturing of | C | C | C | C | C |
| | tube (100 m/min) | | | | | |

| | | | | | |
|---|---|---|---|---|---|
| VW-1 burning test | pass | pass | pass | pass | pass |

Evaluation result of hollow extrusion-molded material having a thickness of 0.8 mm

| | | | | | | |
|---|---|---|---|---|---|---|
| Presence or | in manufacturing of | C | B | B | C | C |
| absence of | tube (20 m/min) | | | | | |
| substance | in manufacturing of | C | C | C | C | C |
| adhering to | tube (100 m/min) | | | | | |
| die portion | | | | | | |

| | | | | | |
|---|---|---|---|---|---|
| VW-1 burning test | fail | fail | fail | pass | pass |

Evaluation result of hollow extrusion-molded material having a thickness of 0.7 mm

| | | | | | | |
|---|---|---|---|---|---|---|
| Presence or | in manufacturing of | C | C | C | C | C |
| absence of | tube (20 m/min) | | | | | |
| substance | in manufacturing of | C | C | C | C | C |
| adhering to | tube (100 m/min) | | | | | |
| die portion | | | | | | |

| | | | | | |
|---|---|---|---|---|---|
| VW-1 burning test | fail | fail | fail | pass | fail |

TABLE 4

| | | Experimental | Experimental | Experimental | Experimental | Experimental |
|---|---|---|---|---|---|---|
| | | Example 17 | Example 18 | Example 19 | Example 20 | Example 21 |
| Base resin | EEA1 | 100 | 100 | 100 | 100 | — |
| | EEA2 | — | — | — | — | — |
| | EEA3 | — | — | — | — | — |
| | LLDPE1 | — | — | — | — | — |
| | EVA1 | — | — | — | — | 100 |
| Flame | bromine-based flame | 50 | 80 | 95 | 80 | 80 |
| retardant | retardant | | | | | |
| | antimony trioxide | | 5 | 20 | 5 | 5 |
| | magnesium hydroxide 1 | 50 | 60 | 55 | — | 30 |
| | magnesium hydroxide 2 | — | — | — | — | — |
| | magnesium hydroxide 3 | — | — | — | — | — |
| | magnesium hydroxide 4 | — | — | — | 30 | — |

Evaluation result of hollow extrusion-molded material having a thickness of 1.0 mm

| Tensile strength (MPa) | | 10.8 | 9.1 | 3.8 | 9.6 | 113 |
|---|---|---|---|---|---|---|
| Tensile elongation (%) | | 410 | 300 | 190 | 310 | 570 |
| Odor | | pass | pass | pass | pass | fail |
| Presence or | in manufacturing | A | A | A | A | A |
| absence of | of electric wire | | | | | |
| substance | (20 m/min) | | | | | |
| adhering to | in manufacturing of | A | C | C | C | A |
| die portion | tube (20 m/min) | | | | | |
| | in manufacturing of | A | C | C | C | A |
| | tube (100 m/min) | | | | | |

| | | | | | |
|---|---|---|---|---|---|
| VW-1 burning test | fail | pass | pass | pass | pass |

Evaluation result of hollow extrusion-molded material having a thickness of 0.8 mm

| | | | | | | |
|---|---|---|---|---|---|---|
| Presence or | in manufacturing of | A | C | C | C | A |
| absence of | tube (20 m/min) | | | | | |
| substance | in manufacturing of | A | C | C | C | A |
| adhering to | tube (100 m/min) | | | | | |
| die portion | | | | | | |

| | | | | | |
|---|---|---|---|---|---|
| VW-1 burning test | fail | pass | pass | pass | pass |

Evaluation result of hollow extrusion-molded material having a thickness of 0.7 mm

| | | | | | | |
|---|---|---|---|---|---|---|
| Presence or | in manufacturing of | A | C | C | C | A |
| absence of | tube (20 m/min) | | | | | |
| substance | in manufacturing of | A | C | C | C | A |
| adhering to | tube (100 m/min) | | | | | |
| die portion | | | | | | |

| | | | | | |
|---|---|---|---|---|---|
| VW-1 burning test | fail | pass | pass | fail | pass |

As shown in Tables 1 to 4, in the case of using the resin composition in which the mass ratio (composition ratio) between the EEA and the LLDPE is within the range of 100:0 to 85:15, and with respect to 100 parts by mass of the total of the EEA and the LLDPE, the content of the bromine-based flame retardant is not less than 55 parts by mass and less than 90 parts by mass, the content of the antimony trioxide is less than 15 parts by mass, and the content of the magnesium hydroxide is less than 50 parts by mass, and the magnesium hydroxide has an average particle size of 0.5 μm to 3.0 μm (Experimental Examples 1 to 10), a die residue does not occur even when full molding and drawdown molding are performed, even when the line speed is as high as 100 m/min, or even when the thickness of the tube is as thin as 0.8 mm or 0.7 mm.

Therefore, the tube having an excellent appearance is expected to be obtained. In addition, a crosslinked polymer of the drawdown-molded product (hollow extrusion-molded material according to the present invention) has flame retardancy that passes the VW-1 burning test, has sufficient tensile strength and tensile elongation, and does not cause an odor problem such as an acetic acid odor.

In Experimental Example 11, the amount of the EEA is 80 mass % (less than 85 mass %) of the total amount of the EEA and the LLDPE. In Experimental Example 11, when the line speed during drawdown molding is as high as 100 m/min, a die residue occurs even if the thickness of the tube is 1.0 mm. Particularly when the thickness is as thin as 0.8 mm and 0.7 mm, a large amount of die residue occurs. When the thickness is as thin as 0.7 mm, a die residue occurs even if the line speed is 20 m/min. In addition, when the thickness is as thin as 0.7 mm, the hollow extrusion-molded material fails the VW-1 burning test and has insufficient flame retardancy. The result of Experimental Example 11 suggests that the amount of the EEA needs to be not less than 85 mass % of the total amount of the EEA and the LLDPE (base resin) in order to obtain the tube having an excellent appearance even when the line speed is high and even when the thickness is thin.

In Experimental Example 12, the amount of the EEA is 70 mass % (less than 85 mass %) of the total amount of the EEA and the LLDPE, and with respect to 100 parts by mass of the total of the EEA and the LLDPE (amount of the base resin), the content of the bromine-based flame retardant is 40 parts by mass (less than 55 parts by mass) and the content of the antimony trioxide is 20 parts by mass (not less than 15 parts by mass). In Experimental Example 13, the base resin is composed only of the EEA (not include the LLDPE), the content of the bromine-based flame retardant is 40 parts by mass (less than 55 parts by mass) and the content of the antimony trioxide is 20 parts by mass (not less than 15 parts by mass). In Experimental Example 14, the base resin is composed only of the EEA, the content of the bromine-based flame retardant is 50 parts by mass (less than 55 parts by mass) and the content of the antimony trioxide is 25 parts by mass (not less than 15 parts by mass). In these Experimental Examples, when the line speed during drawdown molding is as high as 100 m/min, a large amount of die residue occurs even if the thickness of the tube is 1.0 mm, particularly when the thickness is as thin as 0.8 mm and 0.7 mm. Particularly when the thickness is as thin as 0.8 mm and 0.7 mm, a large amount of die residue occurs, and a die residue occurs even if the line speed is 20 m/min.

Furthermore, in Experimental Examples 15, 16 and 19, the base resin is composed only of the EEA, the content of the bromine-based flame retardant is not less than 55 parts by mass, and the content of the antimony trioxide is 20 parts by mass, 30 parts by mass and 20 parts by mass (not less than 15 parts by mass), respectively. In all of these Experimental Examples, a large amount of die residue occurs. These results and the results of Experimental Examples 12, 13 and 14 described above suggest that the content of the antimony trioxide should be less than 15 parts by mass in order to obtain the tube having an excellent appearance.

In Experimental Examples 12 to 14 and 17 in which the content of the bromine-based flame retardant is less than 55 parts by mass, the hollow extrusion-molded material fails the VW-1 burning test and has insufficient flame retardancy, even when the thickness is 0.8 mm. Particularly, in Experimental Example 17 in which the antimony trioxide is not included, the hollow extrusion-molded material fails the VW-1 burning test, even when the thickness is 1.0 mm. These results suggest that the content of the bromine-based flame retardant needs to be not less than 55 parts by mass in order to obtain sufficient flame retardancy even when the thickness is thin.

In addition, in Experimental Example 16 in which the content of the bromine-based flame retardant is 60 parts by mass, the hollow extrusion-molded material fails the VW-1 burning test, even when the thickness is 0.7 mm. This result suggests that the content of the bromine-based flame retardant is preferably not less than 65 parts by mass with respect to 100 parts by mass of the base resin in order to obtain flame retardancy that passes the VW-1 burning test more reliably even when the thickness is thin.

In Experimental Examples 18 and 19, the content of the magnesium hydroxide exceeds 50 parts by mass with respect to 100 parts by mass of the base resin. In Experimental Example 20, the magnesium hydroxide having an average particle size of 7.0 μm (outside the range of not less than 0.5 μm and not more than 3.0 μm) is used. In these Experimental Examples, a large amount of die residue occurs, and a large amount of die residue occurs even when the line speed during drawdown molding is 20 m/min and even when the thickness of the tube is 1.0 mm. This result suggests that the content of the magnesium hydroxide should be not more than 50 parts by mass with respect to 100 parts by mass of the base resin in order to obtain the tube having an excellent appearance, and that the magnesium hydroxide having an average particle size of not more than 3.0 μm should be used.

The tensile strength and the tensile elongation are smaller in Experimental Examples 7 to 9 in which the content of the magnesium hydroxide is 50 parts by mass than in Experimental Examples 1 to 6 in which the content is 30 parts by mass and in Experimental Example 10 in which the content is 10 parts by mass. This result suggests that the content of the magnesium hydroxide is preferably not more than 40 parts by mass. In addition, in Experimental Example 10 in which the content of the magnesium hydroxide is 10 parts by mass, the flame retardancy that passes the VW-1 burning test is obtained even when the thickness is as thin as 0.7 mm.

In Experimental Example 21 in which the EVA is used instead of the EEA or the EEA and the LLDPE, there is an acetic acid odor problem.

1: A hollow extrusion-molded material of a resin composition, the resin composition including, as a base resin, an ethylene-ethyl acrylate copolymer, or an ethylene-ethyl acrylate copolymer and linear low-density polyethylene, the resin composition including a bromine-based flame retardant, antimony trioxide and magnesium hydroxide, wherein
a mass ratio between the ethylene-ethyl acrylate copolymer and the linear low-density polyethylene is 100:0 to 85:15,
with respect to 100 parts by mass of a total of the ethylene-ethyl acrylate copolymer and the linear low-density polyethylene,
a content of the bromine-based flame retardant is not less than 55 parts by mass and less than 90 parts by mass,
a content of the antimony trioxide is less than 15 parts by mass, and
a content of the magnesium hydroxide is less than 50 parts by mass, and
the magnesium hydroxide has an average particle size of not less than 0.5 μm and not more than 3.0 μm.

2: The hollow extrusion-molded material according to claim 1, wherein
with respect to 100 parts by mass of the total of the ethylene-ethyl acrylate copolymer and the linear low-density polyethylene, the content of the bromine-based flame retardant is not less than 65 parts by mass and less than 90 parts by mass.

3: The hollow extrusion-molded material according to claim 2, wherein
with respect to 100 parts by mass of the total of the ethylene-ethyl acrylate copolymer and the linear low-density polyethylene, the content of the magnesium hydroxide is not less than 10 parts by mass and not more than 40 parts by mass.

4: The hollow extrusion-molded material according to claim 1, wherein
the hollow extrusion-molded material is a drawdown-molded material at a shear speed of not higher than 5000 s⁻¹.

5: The hollow extrusion-molded material according to claim 4, wherein
the hollow extrusion-molded material has a thickness of not less than 0.6 mm and not more than 0.9 mm.

6: A crosslinked polymer of the hollow extrusion-molded material, wherein
the base resin that forms the hollow extrusion-molded material as recited in claim 1 is crosslinked.

7: The crosslinked polymer of the hollow extrusion-molded material according to claim 6, wherein
the crosslinked polymer is crosslinked by electron-beam irradiation.

8: A heat-shrinkable tube, being a diameter-enlarged type of the crosslinked polymer of the hollow extrusion-molded material as recited in claim 7.

9: A multilayer heat-shrinkable tube comprising the heat-shrinkable tube as recited in claim 8, and an adhesive layer disposed on an inner circumferential surface of the heat-shrinkable tube and made of a hot melt resin.

10: The multilayer heat-shrinkable tube according to claim 9, wherein
the hot melt resin is a resin selected from the group consisting of an ethylene vinyl acetate copolymer and a polyamide resin.
